(19) United States
(12) Patent Application Publication
(10) Pub. No.: US 2004/0026876 A1
(43) Pub. Date: Feb. 12, 2004

(54) Seal cavity throat protectors

(76) Inventor: Wilhelm Prinz, Helensvale Queensland (AU)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/399,646

(22) PCT Filed: Oct. 19, 2001
(86) PCT No.: PCT/AU01/01342

(30) Foreign Application Priority Data
Oct. 20, 2000 (AU) PR 0910

(51) Int. Cl. F16J 15/50

(52) U.S. Cl. 277/628

(57) ABSTRACT

Rotary shaft (220), housing (250) and packaging type seal (230) together form seal cavity (260). Seal cavity throat protector (200) in cavity (260) protects seal (230) against damaging materials from the region of impeller (210). Such material is directed away from seal (230) along spiral groove(s) (280) on inner surface of protector (200) with the assistance of flushing fluid entering cavity (260) via bore (270) and passing to inner surface of protector (200) via radial bores therethrough.

### FIELD OF THE INVENTION

The invention relates to seal cavity throat protectors for use with rotary fluid equipment.

### BACKGROUND OF THE INVENTION

In this specification, where a document, act or item of knowledge is referred to or discussed, this reference or discussion is not an admission that the document, act or item of knowledge or any combination thereof was at the priority date:

(i) part of common general knowledge; or

(ii) known to be relevant to an attempt to solve any problem with which this specification is concerned.

Rotary fluid equipment usually includes an operative portion such as an impeller which is driven by a prime mover such as a motor. The operative portion usually has a rotating shaft which connects the prime mover to the operative portion. Typically the operative portion is within a housing and the shaft extends through the back of the housing and through a shaft housing. Usually the shaft will be supported by bearings which are between the prime mover and the operative portion.

In use, fluid being moved by the operative portion leaks into the cavity around the shaft. Such fluid may contain various contaminants which arise from erosion of the surfaces of the equipment and which may be abrasive. Therefore it is important to protect the bearings from the damaging effects of material in the fluid.

Seals are used to engage the shaft and prevent fluid which enters the shaft housing from reaching the bearings. The seals are also susceptible to damage by contaminants in the fluid. The seals, shaft housing and shaft define a seal cavity which opens towards the housing containing the operative portion. During operation, the motion of the shaft causes fluid within the seal cavity to rotate and thus impact a centrifugal force on any contaminant material therein. The contaminants are thus directed radially outwardly towards the wall of the seal cavity.

Previous attempts to protect seals in the seal cavity have included attachment of a plate or other member to the rotor at the entrance to the seal cavity, Such a plate assists in elimination of air and assists to prevent fluid from entering the seal cavity as the equipment comes to a halt. In addition, labyrinth-type seals have previously been devised to increase the difficulty of penetration by contaminants into the seal cavity.

Prior U.S. Pat. No. 4,872,690 discloses a seal cavity protector with vent passages through the protector. The reference to this document is by way of illustration of one particular approach to the problem and is not to be construed as an admission that the document is common general knowledge in Australia or was known to persons in Australia at the priority date.

According to U.S. Pat. No. 4,872,690, a pressure differential arises across the vent passages due to rotational flow of the fluid past the vent passages at the entrance to the seal cavity. The pressure differential decreases accumulation of contaminants within the seal cavity due to continuous flow of fluid through the vents. However, it has been found that such protectors tend to create too great a difference in pressure which in turn increases fluid flow into the seal cavity, as well as increasing wear on the shaft and components of the device.

The next step in the protection of seals was the development of grooves or channels on the interior of the seal. Such advances were disclosed in U.S. Pat. Nos. 4,301,893, 4,084,825, 4,301,863 and Australian patent 688,977. While these patents disclosed the use of grooves and seals, there was a problem whereby the contaminants sought to be removed would still affect the seal. The prior art does not disclose a suitable means whereby the contaminants can be expelled from the seal cavity effectively. The prior art does not disclose an effective method of flushing fluid and thus any contaminants through the opening and hence away from the seal.

### SUMMARY OF THE INVENTION

According to a first aspect of the invention, there is provided a throat protector for throat of a seal cavity for rotary equipment, the seal cavity being defined by a rotary shaft with an axis of rotation and a shaft housing surrounding at least a portion of the rotary shaft, said seal cavity being located between seal means and said throat, said throat protector including:

a first part arranged in use to surround a first region of said rotary shaft located at or adjacent said throat, said first part defining with said rotary shaft a passageway for ingress and egress of material through said throat;

a second part arranged in use to surround a second region of said rotary shaft spaced axially from said first region towards said seal means; and

an inner surface of said throat protector having a groove formed therein to direct flow of material through the throat protector towards the throat of said seal cavity, said inner surface having a first part region having the same or greater relative distance from the axis of rotation of the rotary shaft as that of a second part region of said inner surface, and said inner surface further having an enlarged diameter region relative to the first part region of the inner surface located intermediate said first and second parts.

Providing a second part acting as a seal portion in one preferred embodiment capable of engaging the seal means and a groove to direct the flow of material through the throat protector enables material in the fluid to be directed down the groove and back out the opening in the throat protector through the throat of the seal cavity. This in turn decreases the abrasive damage of the seal means by material in the fluid and thereby prolongs the life of the seal means.

According to one preferred embodiment, the seal cavity throat protector is a replaceable bushing. Various bushings according to this embodiment may be used in the same machinery depending on the requirements of the particular application. In addition, worn bushings can be replaced. Preferably a bushing according to the present invention has an outer surface which is adapted to fit in the housing. Preferably it has a complimentary surface. According to another preferred embodiment, the seal cavity throat protector may be integrally formed with the seal housing.

According to a particularly preferred embodiment, there is further provided a bore which passes from the outer surface to the inner surface to allow passage of flushing fluid to flush material back through the open portion of the throat protector. The bore according to this embodiment may be of any suitable type and dimensions. The bore may be at any convenient entry angle relative to the inner and outer surfaces.

According to another preferred embodiment, there may be more than one bore, and these bores may be at any convenient entry angle relative to each other. Where there is more than one bore, then preferably the angle of entry shall be at right angles relative to the other bores.

According to another preferred embodiment, there is an indentation in the outer surface of the throat protector which connects with the bore. Such an indentation defines a cavity to provide a reservoir of flushing fluid to pass through the bore to the inner surface. Preferably the indentation extends along the outer surface. Where the outer surface defines one or more concentric cylinders about the axis of the shaft, then preferably the indentation runs around the circumference of the outer surface. Where there is more than one bore, then preferably they each start in the indentation in the outer surface.

According to another preferred embodiment, where there is an indentation in the outer surface, then preferably the region of enlarged diameter in the inner surface is adjacent to the indentation in the outer surface. Preferably the indentation in the outer surface extends axially along the outer surface. Preferably the region of enlarged diameter in the inner surface runs around the circumference of the inner surface. Where there is more than one bore, then preferably they each enter the inner surface at the indentation in the region of enlarged diameter.

According to a particularly preferred embodiment, the second part of the throat protector is adapted for sealing engagement with the seal. Preferably the second part has an axial end surface with a series of ridges and troughs to assist with sealing engagement with the seal or with packing material. Preferably the ridges and troughs run in concentric circles on the second part which engages with the seal or packing material. According to another preferred embodiment, the seal portion has at least one lip in the inner surface of the throat protector to further increase the sealing effect with the shaft. Preferably there are plurality of lips.

According to another preferred embodiment, the groove defines a spiral along the inner surface of the throat protector. Preferably the spiral of the spiral groove is configured in the same direction as the intended rotation of the shaft. By forming a spiral in the same direction as the shaft, it is possible to maximise the effect of the centrifugal motion of the material in the fluid and thereby force the material towards the open portion of the throat protector and therefrom through the throat. The groove according to the present invention may be continuous along the inner surface of the throat protector. In addition, there may be multiple grooves. Where there are multiple grooves, the grooves start adjacent one end of the throat protector. However, the grooves may start intermediate the ends of the of the throat protector.

According to another preferred embodiment, the groove starts adjacent the seal portion of the throat protector. According to another preferred embodiment, the groove exits the throat protector at an axial end of the first part adjacent to the throat.

According to another preferred embodiment, the volume of groove per unit length of the throat protector varies with distance from the exit end of the throat protector. By varying the volume of groove per unit length of the throat protector, it is possible to vary the amount of pressure applied to the material to force it towards the open portion and therefore vary the flow rate of the material through the throat protector. Such variation is useful in catering for different characteristics of the fluid and contaminants. For example, fluids of different viscosity or temperature, and contaminants of different sizes or densities,

According to one preferred embodiment, the volume of groove per unit length of the throat protector increases with distance from the exit end of the throat protector.

According to another preferred embodiment the volume of groove per unit length of the throat protector decreases with distance from the exit end of the throat protector.

According to another preferred embodiment, the pitch of the spiral groove varies. The volume of groove per unit length of throat protector may also be altered by altering the width of the groove. According to a still further embodiment, the volume of groove per unit length of throat protector is altered by altering the depth of the groove.

According to another preferred embodiment, there is further provided a bore extending through the throat protector between the outer surface and the inner surface to allow egress of air.

In accordance with a second aspect of this invention, there is provided a throat protector for a throat of a seal cavity for rotary equipment, the seal cavity being defined by a rotary shaft with an axis of rotation and a shaft housing surrounding at least a portion of the rotary shaft, said seal cavity being located between seal means and said throat, said throat protector including:

a first part arranged in use to surround a first region of said rotary shaft located at or adjacent said throat, said first part defining with said rotary shaft a passageway for ingress and egress of material through said throat;

a second part arranged in use to surround a second region of said rotary shaft spaced axially from said first region towards said seal means; and

an inner surface of said throat protector having a groove formed therein to direct flow of material through the throat protector towards the throat of said seal cavity, said inner surface having an enlarged diameter region relative to the first part region of the inner surface located intermediate said first and second parts.

Conveniently, the throat protector is replaceable having an outer surface which is adapted to fit into the shaft housing, the throat protector having fluid delivery means for supply of fluid to said enlarged diameter region. Preferably, the fluid delivery means includes at least one bore passing from the outer surface to the inner surface of the throat protector within the enlarged diameter region. The bore or at least one of said bores may have an entry point located within an indentation in the outer surface of the throat protector, said indentation in the outer surface extending around the circumference of the outer surface.

In accordance with a third aspect of this invention, rotary equipment is provided including a rotary shaft having an operative portion rotated by said rotary shaft, said rotary shaft and said operative portion rotating, in use, about an axis of rotation, at least one seal cavity including seal means provided to protect bearing means for said rotary shaft from fluids acted upon by said operative portion, said seal cavity in part being defined by said rotary shaft, a shaft housing surrounding at least a portion of said rotary shaft, a throat leading from a region adjacent said operative portion, and said seal means, said rotary equipment further including a throat protector including a first part surrounding a first region of the rotary shaft located at or adjacent said throat, said first part defining with said rotary shaft a passageway for ingress and egress of material through said throat;

a second part arranged to surround a second region of said rotary shaft spaced axially from said first region towards said seal means; and

an inner surface of said throat protector having a groove formed therein to direct flow of material through the throat protector towards the throat of said seal cavity, said inner surface having an enlarged diameter region relative to the first part region of the inner surface located intermediate said first and second parts, and fluid delivery means for supply of flushing fluid through said shaft housing and into said enlarged diameter region.

Conveniently, the fluid delivery means includes at least one passage through said shaft housing leading into said seal cavity. Preferably, said fluid delivery means includes at least one bore leading from an outer surface of said throat protector to said inner surface within said enlarged diameter region, the or each said bore in said throat protector having an entry in communication with a said passage for flushing fluid delivery provided through said shaft housing.

### DESCRIPTION OF THE DRAWINGS

The invention will now be further explained and illustrated by reference to the accompanying drawings showing several preferred embodiments of the present invention, in which:

FIG. 1 is a cross sectional view of the seal cavity schematically showing a bushing according to the present invention.

FIG. 2 is a side view of a seal cavity throat bushing according to the present invention.

FIG. 3 is a cross sectional view of a seal cavity throat protector according to the present invention depicting the inner surface.

FIG. 4 is an end view of the seal portion of the sectioned throat protector of FIG. 3.

FIG. 5 is a cross sectional view of the seal cavity showing the bushing in use in pump packing.

FIG. 6 is a cross sectional view of the seal cavity showing the bushing in use in a mechanical seal.

### DESCRIPTION OF PREFERRED EMBODIMENT

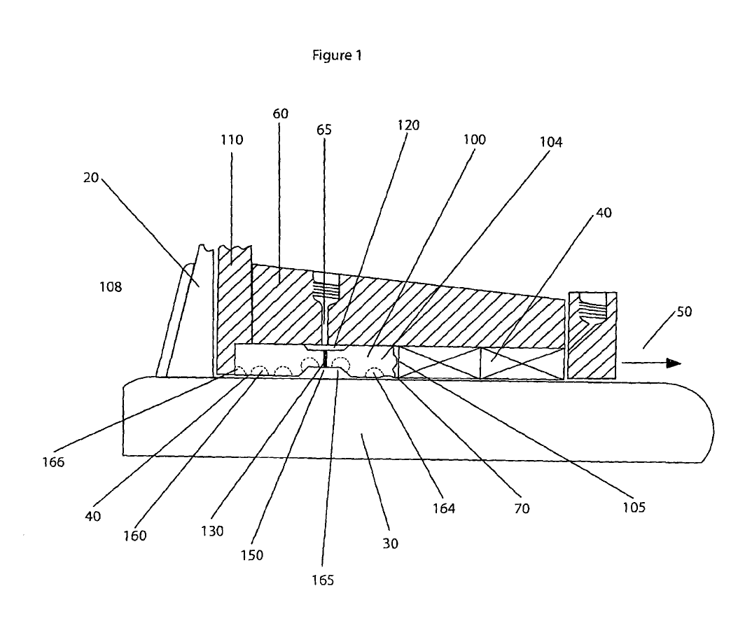

FIG. 1 depicts a typical environment for a seal cavity throat protector in the form of a bushing according to the present invention which is shown generally at 100. The environment includes an operative portion such as an impeller 20, which is connected to a shaft 30, the shaft 30 being connected to a prime mover such as a motor 40 (not shown). Seals 40 protect bearings which support the shaft which would be further along the shaft in the direction of arrow 50. Shaft 30 together with shaft housing 60 and seals 40 form a seal cavity shown generally at 70.

Bushing 100 has a seal portion 104 adapted to surround the shaft and to engage a seal 40, and an open portion 108 adapted to surround the shaft and to define with the shaft a passageway for ingress and egress of material. Bushing 100 has an outer surface 110 with a circumferential indentation 120, into which a bore 65 through shaft housing 60 empties. Bushing 100 further has a bore 130 which runs from outer surface 110 to inner surface 140. Bore 130 opens into indentation 150 in inner surface 140.

FIGS. 1 and 3 demonstrate inner surface 140 having several spiral grooves, shown generally at 160. The hand of each spiral groove is in the same direction as the rotation of the shaft. The first spiral groove, 164 starts inside the bushing in the seal portion and ends at indentation 150. The second spiral groove, 165 runs along indentation 150 in inner surface 140. The third spiral groove, starts at indentation 150 and continues out of the end of the open portion 108.

Seal portion 104 has a series of ridges and troughs 105 which run in concentric circles on the part 106 of the seal portion 104 which engages with the adjacent seal 40, in use.

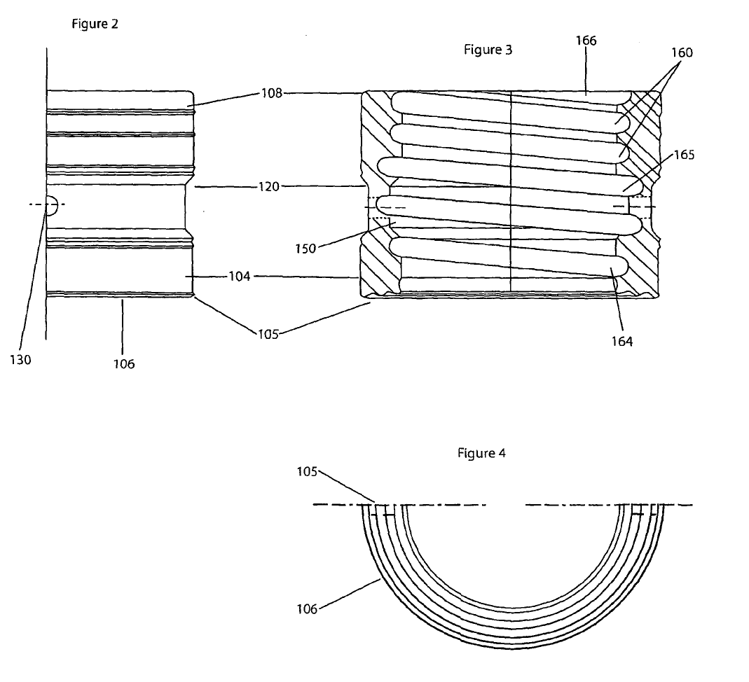

FIG. 2 demonstrates the features of the outer surface 110 of bushing 100. Outer surface 110 has a circumferential indentation 120. There is a bore 130 which runs from outer surface 110 to the inner surface 140. Seal portion 104 has a series of ridges and troughs 105 which run in concentric circles on the part 106 of the seal portion 104 which engages with the seal 40.

FIG. 4 demonstrates an end view of the series of ridges and troughs 105 which run in concentric circles on the part 106 of the seal portion 104 which engages with the seal 40.

In use, shaft 30 and impeller 20 rotate and thereby cause fluid surrounding the impeller to be moved in the desired direction. Fluid being moved by the operative portion leaks into seal cavity 70. Such fluid may contain various contaminants which arise from erosion of the surfaces of the equipment and which may be abrasive.

Seals 40 protect the bearings on which shaft 30 sits. The seals are themselves protected by bushing 100 which, in the embodiment shown in FIGS. 1 to 5, engages with and forms a seal with a seal 40 by virtue of the ridges and troughs 105 on the axially facing end portion 106 of the seal portion 104.

The rotational action of shaft 30 imparts a rotational movement to the fluid surrounding shaft 30 in seal cavity 70. Material in the fluid is forced by the rotational movement of shaft 30 along grooves 164,165 and 166 towards open portion 108 and out of the opening surrounding the shaft 30 at the axial end of the bushing 100 adjacent to the impeller 20.

Additionally, flushing fluid enters circumferential indentation 120 on outer surface 110 via bore 65. Flushing fluid builds in indentation 120 and then runs down bore 130 from outer surface 110 to the inner surface 140. Material in the fluid in seal cavity 70 is thereby flushed down grooves 165 and 166 towards open portion 108 and out the opening.

Inner surface 140 has an indentation 150 and a spiral groove 160 which starts inside the bushing in the seal portion 164, but continues out of the end of the open portion 165.

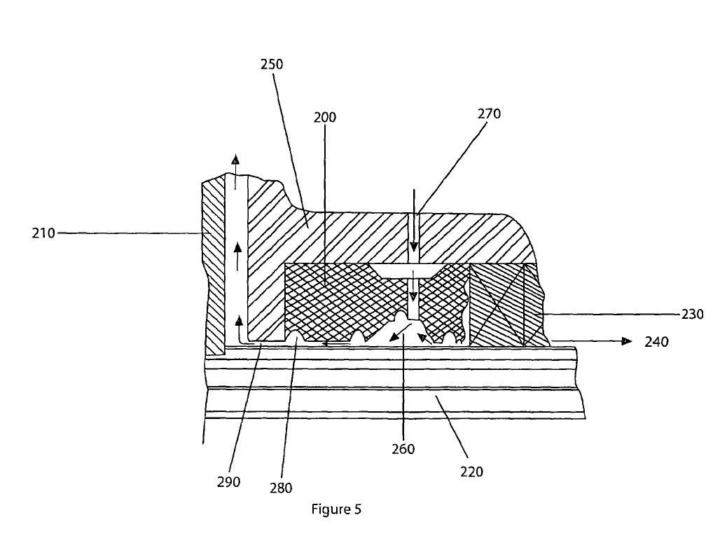

FIG. 5 depicts a typical further environment for a seal cavity throat bushing 200 according to a further preferred embodiment of the present invention for use as a pump packing. The operative portion of the environment for this embodiment is a pump impeller 220, which is connected to a shaft 230. Packing or seals 240 protect the bearings which support the shaft 220 which would be further along the shaft in the direction of arrow 250. Shaft 230 together with shaft housing 275 and packing 240 form a seal cavity shown generally at 270.

Flushing fluid enters the cavity 270 through a bore 265, outer bushing surface indentation or cavity 225, bore 235 in the bushing 200 and inner bushing surface indentation or cavity 255 and thereafter moves through the throat protector bushing 200 along the spiral grooves 260 and ultimately exits the cavity at a throat 290 leading from the shaft housing 270.

As shown in FIG. 5, the bore 235 in the bushing 200 is off set as it enters the intermediate cavity 255 in the bushing 200 so as to provide a fluid flow direction component as indicated by the arrows in FIG. 5 towards the throat 290.

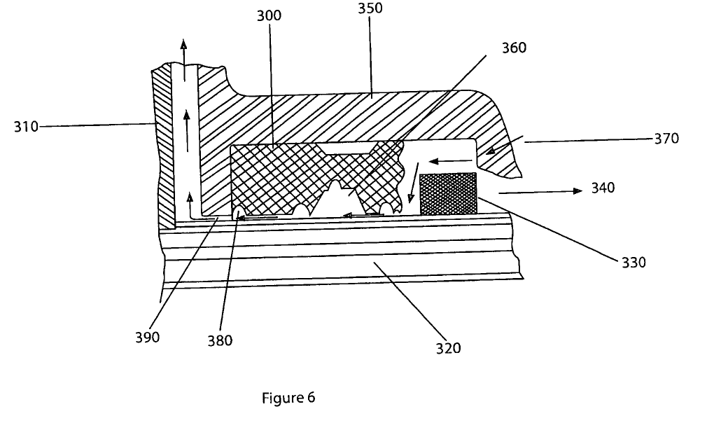

FIG. 6 depicts a typical environment for a further preferred embodiment of a seal cavity throat protector in the form of a bushing according to the present invention for use in a mechanical seal which is shown at 300. The operative portion is an impeller 320, which is connected to a rotational shaft 330. A seal 340 rotational with shaft 330 and cooperable mechanically with a second stationary seal member is, in a known manner provided to protected bearings which support the shaft 330 which would be further along the shaft in the direction of arrow 350. Shaft 330 together with shaft housing 375 and seals 340 form a seal cavity shown generally at 370. Flushing fluid enters the cavity through the bore at 365 in the shaft housing 375 and moves between seals 340 and the face 306 of the bushing 300 as indicated by the arrows, the flushing fluid then moves axially into the cavity 355 intermediate the axial ends of the bushing and along the bushing 300 via the spiral groves 360 and ultimately exits the seal cavity 370 at the throat 390.

The word ‘comprising’ and forms of the word ‘comprising’ as used in this description do not limit the invention claimed to exclude any variants or additions.

Modifications and improvements to the invention will be readily apparent to those skilled in the art. Such modifications and improvements are intended to be within the scope of this invention.

### BENEFITS OF THE INVENTION

This invention reduces flush by 50 to 80%. It also increases packing life by 2 to 3 times. The invention requires less packing. The invention reduces shaft wear and sleeve wear and requires fewer gland adjustments.

1. A throat protector for a throat of a seal cavity for rotary equipment, the seal cavity being defined by a rotary shaft with an axis of rotation and a shaft housing surrounding at least a portion of the rotary shaft, said seal cavity being located between seal means and said throat, said throat protector including:
a first part arranged in use to surround a first region of said rotary shaft located at or adjacent said throat, said first part defining with said rotary shaft a passageway for ingress and egress of material through said throat;
a second part arranged in use to surround a second region of said rotary shaft spaced axially from said first region towards said seal means; and
an inner surface of said throat protector having a groove formed therein to direct flow of material through the throat protector towards the throat of said seal cavity, said inner surface having a first part region having the same or greater relative distance from the axis of rotation of the rotary shaft as that of a second part region of said inner surface, and said inner surface further having an enlarged diameter region relative to the first part region of the inner surface located intermediate said first and second parts.

2. The throat protector of claim 1 wherein, the throat protector is replaceable.

3. The throat protector of claim 1 having an outer surface which is adapted to fit in the shaft housing.

4. The throat protector of claim 1 wherein, the throat protector is integrally formed with the shaft housing.

5. The throat protector of claim 1 having, at least one bore passing from the outer surface to the inner surface of the throat protector.

6. The throat protector of claim 3 having, an indentation in the outer surface and at least one bore passing from the indentation to the inner surface of the throat protector.

7. The throat protector of claim 6 having at least two said bores.

8. The throat protector of claim 6 having at least two said bores entering the inner surface of the throat protector, the angle of entry of the bores being at right angles.

9. The throat protector of claim 6 wherein, the indentation in the outer surface of the throat protector extends around a circumference of the outer surface.

10. The throat protector of any one of claims 6 to 9 wherein the or each said bore opens into the enlarged diameter region of said inner surface.

11. The throat protector of claim 10 wherein the indentation in the outer surface extends around the circumference of the outer surface and is positioned axially at or adjacent the enlarged diameter region of said inner surface.

12. The throat protector of claim 5 having at least two said bores entering the inner surface at said enlarged diameter region of the inner surface.

13. The throat protector of claim 1 wherein, the second part is adapted for sealing engagement with said seal means.

14. The throat protector of claim 13 wherein an axial end surface of said second part of the throat protector has concentric ridges and troughs adapted in use to sealingly engage with said seal means.

15. The throat protector of claim 14 wherein, the second part of the throat protector has at least one sealing lip in the inner surface of the throat protector.

16. The throat protector of any one of claims 1 to 15 wherein, the groove defines a spiral along the inner surface of the throat protector.

17. The throat protector of claim 16 wherein, the spiral groove has a spiral direction in the same direction as rotation of the rotary shaft.

18. The throat protector of claim 16 or claim 17 wherein, the groove is continuous along the inner surface of the throat protector.

19. The throat protector of claim 1 having multiple said grooves.

20. The throat protector of claim 19 wherein, the grooves start adjacent an axial end of the second part of the throat protector.

21. The throat protector of claim 19 wherein, the grooves start intermediate axial ends of the throat protector.

22. The throat protector of claim 1 wherein, the groove starts adjacent the second part of the throat protector.

23. The throat protector according to claim 1 wherein, the groove exits the throat protector at an axial end of the first part of the throat protector.

24. The throat protector according to claim 1 wherein, the groove has a volume per unit length of the throat protector that varies with distance from an exit end of the throat protector located in use at or adjacent said throat.

25. The throat protector according to claim 24 wherein, the groove volume per unit length of the throat protector increases with distance from the exit end of the throat protector.

26. The throat protector according to claim 24 wherein, the groove volume per unit length of the throat protector decreases with distance from the exit end of the throat protector.

27. The throat protector of claim 1 wherein, the groove is spirally configured and has a variable pitch axially along said throat protector.

28. The throat protector of claim 1 wherein, the groove has a groove volume per unit length of throat protector that is altered by altering the width of the groove.

29. The throat protector of claim 1 wherein, the groove has a groove volume per unit length of the throat protector that is altered by altering a depth of the groove.

30. The throat protector of claim 5 wherein, a said bore extends through the throat protector between the outer surface and the inner surface to allow egress of air.

31. A throat protector substantially as hereinbefore described with reference to the accompanying drawings.

32. A throat protector for a throat of a seal cavity for rotary equipment, the seal cavity being defined by a rotary shaft with an axis of rotation and a shaft housing surrounding at least a portion of the rotary shaft, said seal cavity being located between seal means and said throat, said throat protector including:
a first part arranged in use to surround a first region of said rotary shaft located at or adjacent said throat, said first part defining with said rotary shaft a passageway for ingress and egress of material through said throat;
a second part arranged in use to surround a second region of said rotary shaft spaced axially from said first region towards said seal means; and
an inner surface of said throat protector having a groove formed therein to direct flow of material through the throat protector towards the throat of said seal cavity, said inner surface having an enlarged diameter region relative to the first part region of the inner surface located intermediate said first and second parts.

33. The throat protector of claim 32 wherein, the throat protector is replaceable having an outer surface which is adapted to fit into the shaft housing, the throat protector having fluid delivery means for supply of fluid to said enlarged diameter region.

34. The throat protector of claim 33 wherein said fluid delivery means includes at least one bore passing from the outer surface to the inner surface of the throat protector within the enlarged diameter region.

35. The throat protector of claim 34 wherein the bore or at least one of said bores has an entry point located within an indentation in the outer surface of the throat protector, said indentation in the outer surface extending around the circumference of the outer surface.

36. Rotary equipment including at least one throat protector for a seal cavity according to any one of claims 1 to 35.

37. Rotary equipment including a rotary shaft having an operative portion rotated by said rotary shaft, said rotary shaft and said operative portion rotating, in use, about an axis of rotation, at least one seal cavity including seal means provided to protect bearing means for said rotary shaft from fluids acted upon by said operative portion, said seal cavity in part being defined by said rotary shaft, a shaft housing surrounding at least a portion of said rotary shaft, a throat leading from a region adjacent said operative portion, and said seal means, said rotary equipment further including a throat protector including a first part surrounding a first region of the rotary shaft located at or adjacent said throat, said first part defining with said rotary shaft a passageway for ingress and egress of material through said throat;
a second part arranged to surround a second region of said rotary shaft spaced axially from said first region towards said seal means: and
an inner surface of said throat protector having a groove formed therein to direct flow of material through the throat protector towards the throat of said seal cavity, said inner surface having an enlarged diameter region relative to the first part region of the inner surface located intermediate said first and second parts, and fluid delivery means for supply of flushing fluid through said shaft housing and into said enlarged diameter region.

38. Rotary equipment according to claim 37 wherein said fluid delivery means includes at least one passage through said shaft housing leading into said seal cavity.

39. Rotary equipment according to claim 38 wherein, said fluid delivery means includes at least one bore leading from an outer surface of said throat protector to said inner surface within said enlarged diameter region, the or each said bore in said throat protector having an entry in communication with a said passage for flushing fluid delivery provided through said shaft housing.
